(19) United States
(12) Patent Application Publication
(10) Pub. No.: US 2026/0057066 A1
(43) Pub. Date: Feb. 26, 2026

(54) REPLAY ATTACK PROTECTION IN AUTOMOTIVE ELECTRONICS

(71) Applicant: QUALCOMM Incorporated, San Diego, CA (US)

(72) Inventors: Nishant RAJ, Bhagalpur (IN); Yashavantha RAO, Hyderabad (IN); Piyush TEWARI, Lucknow (IN); Ananda Kishore PARASA, Hyderabad (IN); Shyam MAHESHWARI, Hyderabad (IN); Sourav Kumar PUNORIYAR, Hyderabad (IN)

(21) Appl. No.: 18/812,420

(22) Filed: Aug. 22, 2024

(51) Int. Cl. G06F 21/55; G06F 8/65

(52) U.S. Cl. CPC G06F 21/554; G06F 8/65; G06F 2221/034

(57) ABSTRACT

Aspects of the disclosure are directed to replay attack protection. In accordance with one aspect, the disclosure includes establishing a secure channel between a lightweight electronics control unit (ECU) and a central electronics control unit (ECU); sending a read/write sensitive software data request message from the lightweight ECU to the central ECU; reading a first sensitive software data as part of a programming update using a replay protected memory region; writing a second sensitive software data as part of the programming update using the replay protected memory region; and providing the first sensitive software data and the second sensitive software data to the central ECU as part of the programming update.

### TECHNICAL FIELD

This disclosure relates generally to the field of automotive electronics systems, and, in particular, to replay attack protection for an electronic control unit (ECU) in an automotive electronics system.

### BACKGROUND

An automotive electronics system, such as an electronic control unit (ECU), is subject to stringent safety requirements. In an automobile, there are several ECUs with specific hardware and software configurations which provide distributed monitoring and control of the automotive electronics system. However, since an ECU is vulnerable to a replay attack, protection is needed in the automotive electronics system for automotive system security.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides replay attack protection. Accordingly, the present disclosure discloses an apparatus including: a lightweight electronics control unit (ECU) configured to monitor and control functions of one or more automotive subsytems; a central electronics control unit (ECU) coupled to the lightweight ECU, the central ECU configured to execute a programming update for the lightweight ECU; and a secure channel coupled between the lightweight ECU and the central ECU, the secure channel configured to expose a replay protected memory region to the lightweight ECU.

In one example, the replay protected memory region for the programming update resides within the central ECU. In one example, the programming update is a software update. In one example, the programming update is a firmware update. In one example, the lightweight ECU has limited memory resources, limited one-time programmable (OTP) registers or limited non-volatile memory (NVM). In one example, the lightweight ECU has no hardware security module (HSM).

Another aspect of the disclosure provides a method including: establishing a secure channel between a lightweight electronics control unit (ECU) and a central electronics control unit (ECU); sending a read/write sensitive software data request message from the lightweight ECU to the central ECU; reading a first sensitive software data as part of a programming update using a replay protected memory region; writing a second sensitive software data as part of the programming update using the replay protected memory region; and providing the first sensitive software data and the second sensitive software data to the central ECU as part of the programming update.

In one example, the lightweight ECU has limited memory resources, limited one-time programmable (OTP) registers or limited non-volatile memory (NVM). In one example, the lightweight ECU has no hardware security module (HSM). In one example, the secure channel is implemented as an upper transport layer on a lower network layer. In one example, the secure channel includes a hierarchy of protocol data units (PDUs). In one example, each of the hierarchy of PDUs includes a header and a payload. In one example, the header includes routing information and control plane information, and the payload includes data plane information.

In one example, the method further includes relaying a message to indicate completion of a successful programming update or a failed programming update. In one example, the method further includes receiving a confirmation message from the central ECU that the secure channel is established. In one example, the method further includes determining if a memory resource in the lightweight ECU is adequate for the programming update. In one example, the method further includes initiating the programming update for the lightweight ECU.

Another aspect of the disclosure provides a non-transitory computer-readable medium storing computer executable code, operable on a device including at least one processor and at least one memory coupled to the at least one processor, wherein the at least one processor is configured to implement replay attack protection, the computer executable code including: instructions for causing a computer to establish a secure channel between a lightweight electronics control unit (ECU) and a central electronics control unit (ECU); instructions for causing the computer to send a read/write sensitive software data request message from the lightweight ECU to the central ECU; instructions for causing the computer to read a first sensitive software data as part of a programming update using a replay protected memory region; instructions for causing the computer to write a second sensitive software data as part of the programming update using the replay protected memory region; and instructions for causing the computer to provide the first sensitive software data and the second sensitive software data to the central ECU as part of the programming update.

In one example, the non-transitory computer-readable medium further includes instructions for causing the computer to relay a message to indicate completion of a successful programming update or a failed programming update. In one example, the non-transitory computer-readable medium further includes instructions for causing the computer to receive a confirmation message from the central ECU that the secure channel is established.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example automotive electronics system with a plurality of electronic control units (ECUs).

FIG. 2 illustrates an example of a plurality of lightweight electronic control units (ECUs) in an automotive electronics system.

FIG. 3 illustrates an example of a plurality of lightweight electronic control units (ECUs) with vulnerabilities.

FIG. 4 illustrates an example automotive electronics system with enhanced replay attack protection.

FIG. 5 illustrates an example use-case flow diagram for enhanced replay attack protection in an automotive electronics system.

FIG. 6 illustrates an example flow diagram 600 for implementing replay attack protection.

FIG. 7 illustrates an example use-case flow diagram for enhanced replay attack protection in an automotive electronics system with update decision by a central electronics control unit (ECU).

FIG. 8 illustrates an example use-case flow diagram for enhanced replay attack protection in an automotive electronics system with update decision by a lightweight electronics control unit (ECU).

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In contemporary automobiles, an automotive electronics system is pervasive and is a critical part of the automotive operation. For example, the automotive electronics system monitors and controls various automotive subsystems, such as the engine, powertrain, transmission, braking, body, suspension, power steering, battery, etc. In one example, an automobile uses a large quantity of automotive electronic control units (ECUs). As a consequence, integrity and fault protection of automotive ECUs are critical requirements.

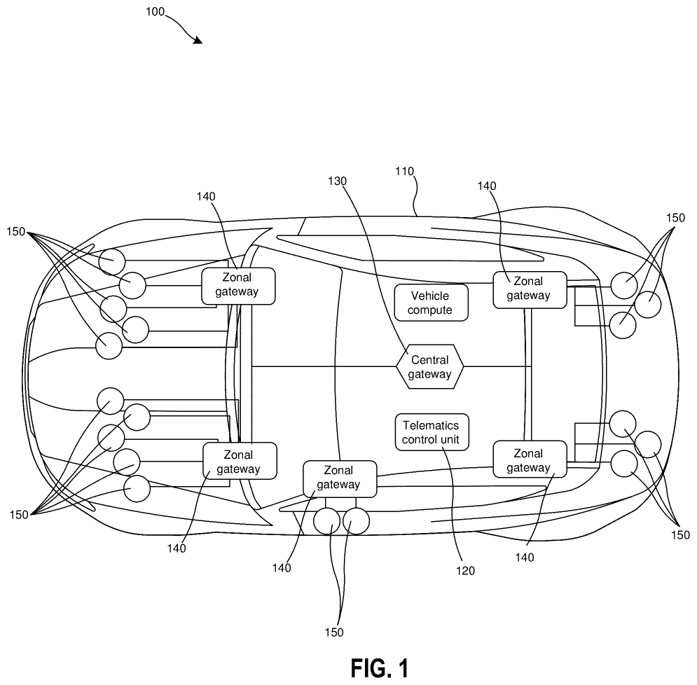

FIG. 1 illustrates an example automotive electronics system 100 with a plurality of electronic control units (ECUs). In one example, a vehicle computer 110 serves as a processing nexus (e.g., a centralized processing engine) for the automotive electronics system 100. In one example, a telematics control unit 120 is used as a communications controller for the automotive electronics system 100. In one example, a central gateway 130 serves as a routing nexus (e.g., a hub) for a plurality of network interconnections. In one example, the automotive electronics system 100 also includes a plurality of zonal gateways 140 which serve as network routers or switches for the plurality of network interconnections. In one example, the plurality of zonal gateways 140 also serve as network aggregators for a plurality of ECUs 150 in the automotive electronics system 100.

In one example, the automobile includes a plurality of ECUs to perform various monitoring and control functions of several automotive subsystems. Each ECU of the plurality of ECUs may have a specific configuration of hardware and software elements. In one example, an ECU may require data storage with replay protection against a replay attack. In one example, replay protection may be especially needed for certain critical operational scenarios such as anti-rollback during a software update or safeguarding of sensitive data.

In one example, a replay attack is a security vulnerability where a malicious party may intercept a secure message from an authorized source to an authorized destination and retransmit the intercepted secure message at some future time. In one example, the replay attack may be successful even if the secure message cannot be decrypted by the malicious party.

In one example, one or more of the plurality of ECUs may be limited by ECU hardware constraints. For example, an ECU with hardware constraints (e.g., limited memory resources) may be designated as a lightweight ECU. For example, ECU hardware constraints may include a limited quantity of one-time programmable (OTP) registers, a lack of hardware security modules (HSMs), and/or a constrained non-volatile memory (NVM) product footprint. In one example, an ECU without hardware constraints (e.g., with sufficient memory resources) may be designated as a heavyweight ECU. As a consequence of ECU hardware constraints, a lightweight ECU may be vulnerable to a replay attack. In one example, replay attack vulnerability needs mitigation to improve system security.

In one example, OTP registers are specific registers which may be written into only once to provide a secure data repository. In one example, a HSM is a specialized hardware unit dedicated for secure processing (e.g., encryption and decryption). In one example, a NVM is an electronic storage device which retains its memory state even when disconnected from an electrical power supply or battery.

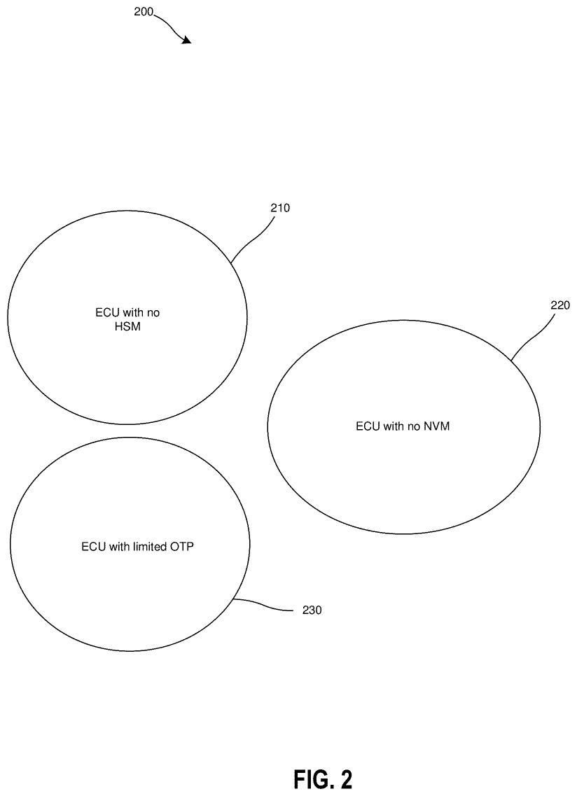

FIG. 2 illustrates an example of a plurality of lightweight electronic control units (ECUs) 200 in an automotive electronics system. In one example, the plurality of lightweight ECUs 200 includes a first ECU 210 with no hardware security module (HSM), a second ECU 220 with no non-volatile memory (NVM) and a third ECU 230 with limited one-time programmable (OTP) registers.

In one example, a replay attack may be an anti-rollback threat. In one example, if vulnerable software or firmware of a lightweight ECU is rolled back due to an absence of adequate anti-rollback infrastructure, there may be a risk to the entire automotive electronics system. In one example, rollback refers to a restoration of a previous version of software or system state. In one example, anti-rollback refers to a security technique to prevent an unauthorized rollback. In one example, an anti-rollback threat is an attack to exploit a vulnerability in an anti-rollback feature. In one example, the replay attack may be a data integrity threat. Without proper protection, sensitive data may be vulnerable to replacement by outdated or stale information.

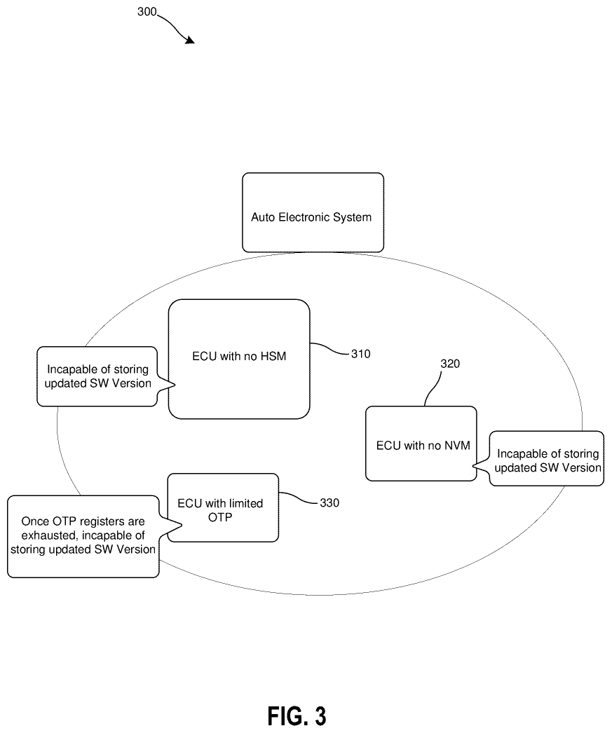

FIG. 3 illustrates an example of a plurality of lightweight electronic control units (ECUs) 300 with vulnerabilities. In one example, a first ECU 310 with no hardware security module (HSM) is incapable of storing an updated software version. In one example, a second ECU 320 with no non-volatile memory (NVM) is incapable of storing an updated software version. In one example, a third ECU 330 with limited one-time programmable (OTP) registers is incapable of storing an updated software version once OTP registers are exhausted.

In one example, some ECUs of the plurality of ECUs are known as heavyweight ECUs. In one example, heavyweight ECUs may have replay protected memory regions. In one example, a replay protected memory region may be partitioned into a memory carveout for storage usage by other ECUs (e.g., lightweight ECUs). In one example, a memory carveout is a portion of memory allocated for a specific purpose or client. For example, each lightweight ECU may have a dedicated memory carveout in one or more heavyweight ECUs.

In one example, the plurality of ECUs may communicate among themselves using an inter-processor secure channel. In one example, the inter-processor secure channel may be implemented as an upper transport layer on a lower network layer such as, but not limited to, a controller area network (CAN), Ethernet, etc. In one example, the inter-processor secure channel may be used by the plurality of ECUs to establish a secure communications facility between lightweight ECUs (e.g., ECU with limited memory resources) and heavyweight ECUs (e.g., ECUs with sufficient memory resources).

In one example, the inter-processor secure channel may include a hierarchy of protocol data units (PDUs). In one example, a PDU is a formatted plurality of bits with a header and a payload. The header may include routing information and control plane information. The payload may include data plane information. In one example, control plane information is used for configuration of data transport resources. In one example, data plane information is end user information transported from a source to a destination. In one example, the inter-processor secure channel transports an authentic PDU to support authentication and a secured PDU to support secure transmission.

In one example, the inter-processor secure channel may be used to expose (i.e., make available) replay protected memory regions to lightweight ECUs. In one example, one or more replay protected memory regions reside within heavyweight ECUs. In another example, one or more replay protected memory regions are coupled to the heavyweight ECUs but are external to the heavyweight ECUs. In one example, lightweight ECUs may then store replay protected data by leveraging hardware from heavyweight ECUs which have replay protected memory regions. In one example, the inter-processor secure channel mitigates security threats due to a replay attack.

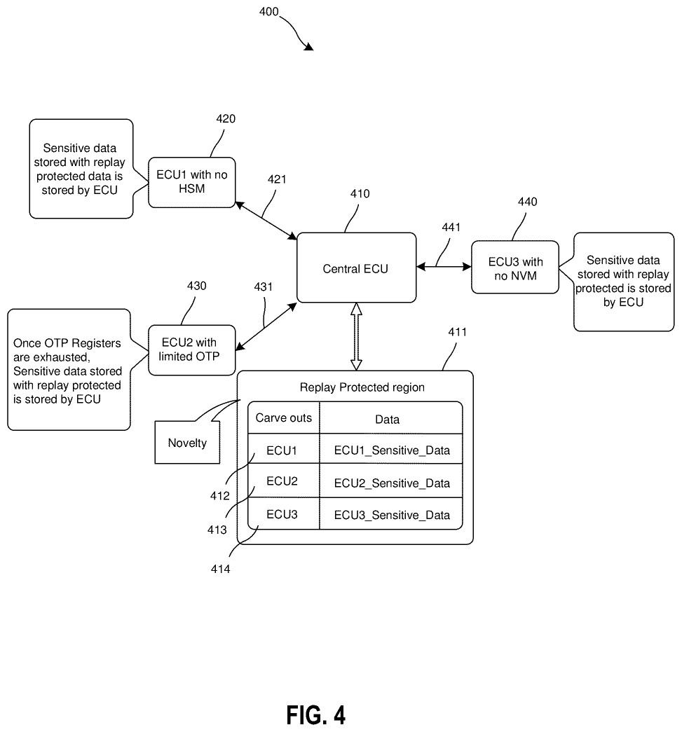

FIG. 4 illustrates an example automotive electronics system 400 with enhanced replay attack protection. In one example, a central electronic control unit (ECU) 410 serves as a processing nexus for the automotive electronics system 400. In one example, the central ECU 410 is a heavyweight ECU (e.g. with sufficient memory resources). In one example, the central ECU 410 is connected to a first lightweight ECU 420 (ECU 1) via a first inter-processor secure channel 421, to a second lightweight ECU 430 (ECU 2) via a second inter-processor secure channel 431 and to a third lightweight ECU 440 (ECU 3) via a third inter-processor secure channel 441. In one example, the first lightweight ECU 420 has no hardware security module (HSM). In one example, the second lightweight ECU 430 has limited one-time programmable (OTP) registers. In one example, the third lightweight ECU 440 has no non-volatile memory (NVM).

In one example, the central ECU 410 includes a replay protected memory region 411. In one example, the replay protected memory region 411 includes a first memory carveout 412, a second memory carveout 413 and a third memory carveout 414.

In one example, the first memory carveout 412 is allocated to the first lightweight ECU 420 where its sensitive data is stored with replay protection by the central ECU 410 using the first inter-processor secure channel 421. In one example, the second memory carveout 413 is allocated to the second lightweight ECU 430 where its sensitive data is stored with replay protection by the central ECU 410 using the second inter-processor secure channel 431 once its OTP registers are exhausted. In one example, the third memory carveout 414 is allocated to the third lightweight ECU 440 where its sensitive data is stored with replay protection by the central ECU 410 using the third inter-processor secure channel 441. In one example, usage of replay protected memory region 411 in the central ECU 410 by the first lightweight ECU 420, the second lightweight ECU 430 and the third lightweight ECU 440 improves overall security of the automotive electronics system 400 by enhancing replay attack protection.

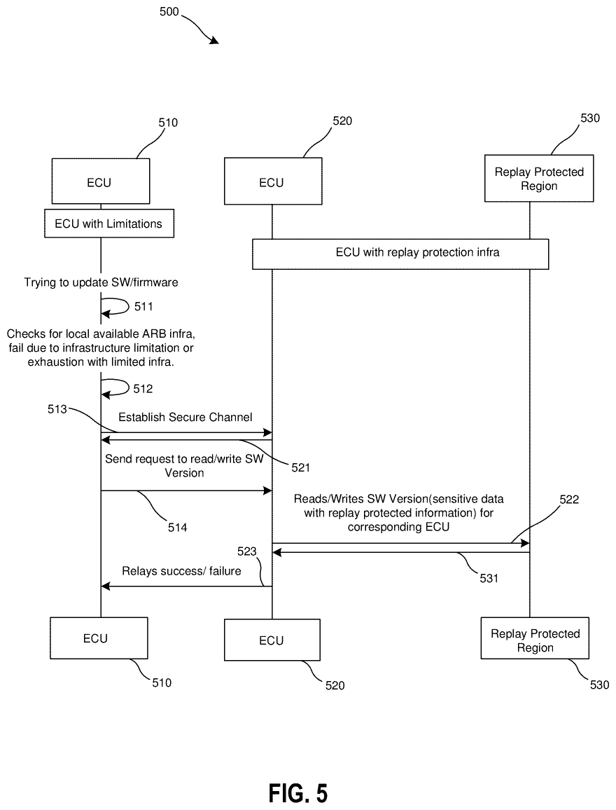

FIG. 5 illustrates an example use-case flow diagram 500 for enhanced replay attack protection in an automotive electronics system. In one example, there are three elements in this use case flow diagram: a lightweight ECU 510, a central ECU (e.g., heavyweight ECU) 520 and a replay protected memory region 530. In one example, the replay protected memory region 530 is part of the central ECU 520. In one example, the lightweight ECU 510 has limited memory resources. In one example, the central ECU 520 has sufficient memory resources (i.e., includes the replay protected memory region 530).

In one example, the use-case flow diagram 500 commences in step 511 with an initiation of a software update or a firmware update in the lightweight ECU 510. In one example, the lightweight ECU 510 determines in step 512 that a check of locally available anti-rollback (ARB) infrastructure has failed due to a lack of resources or infrastructure or due to exhaustion of suitable memory resources (i.e., OTP registers). In one example, in step 513, the lightweight ECU 510 establishes a secure channel with the central ECU 520. In one example, in step 521, the central ECU 520 confirms establishment of the secure channel with the lightweight ECU 510. For example, the confirmation may be an acknowledgement message.

In one example, the lightweight ECU 510 sends a read/write sensitive software data request message in step 514 to the central ECU 520. In one example, the central ECU 520 reads and writes sensitive software data as part of the software update or the firmware update in step 522 using the replay protected memory region 530. In one example, in step 531, the replay protected memory region 530 stores and provides the sensitive software data to the central ECU 520 as part of the software update or the firmware update. In one example, in step 523, the central ECU 520 relays to the lightweight ECU 510 a success/failure message to indicate or not a successful software update or the firmware update. Per the use-case flow diagram convention, ECU 510, ECU 520 and the replay protected memory region 530 are each shown twice in FIG. 5, at the beginning of the flow and at the end of the flow.

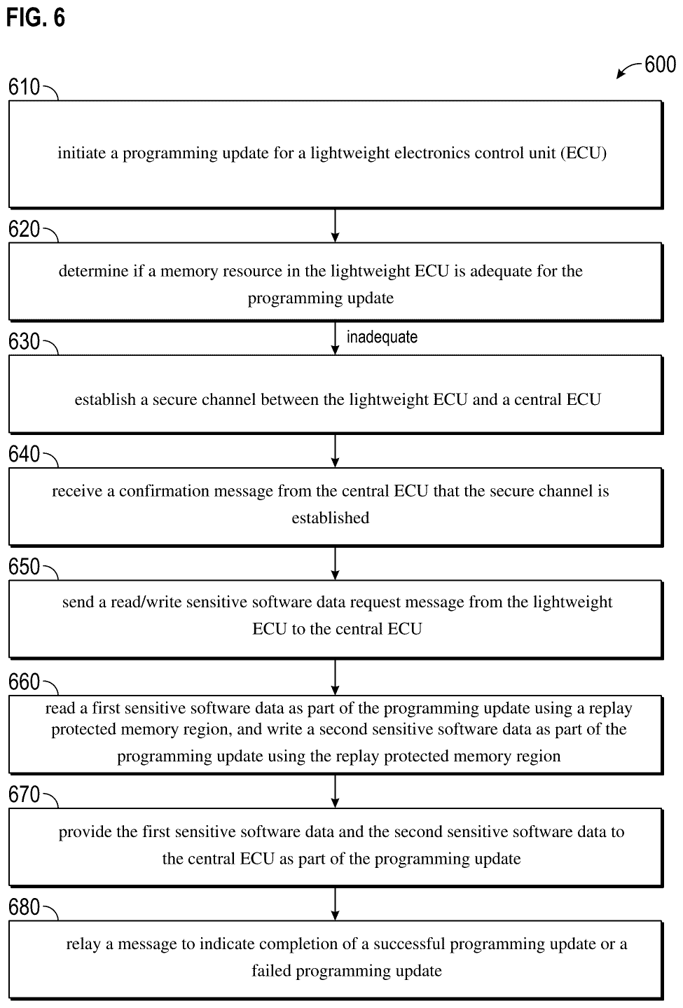

FIG. 6 illustrates an example flow diagram 600 for implementing replay attack protection. In block 610, initiate a programming update for a lightweight electronics control unit (ECU). In one example, a programming update is initiated for a lightweight electronics control unit (ECU). In one example, the programming update is a software update. In another example, the programming update is a firmware update. In one example, the lightweight ECU controls one or more subsystems in an automotive electronics system. In one example, the lightweight ECU has limited memory resources. In one example, the lightweight ECU has limited one-time programmable (OTP) registers or limited non-volatile memory (NVM). In one example, the lightweight ECU has no hardware security module (HSM). In one example, software is programmable instructions which is written independent of an underlying hardware platform. In one example, firmware is programmable instructions which is specific to the underlying hardware platform. In one example, the step of block 610 is performed by a lightweight electronics control unit (ECU).

In block 620, determine if a memory resource in the lightweight ECU is adequate for the programming update. In one example, a memory resource in the lightweight ECU is determined if it is adequate for the programming update. If the memory resource is adequate, then proceed with the programming update natively (i.e., within the lightweight ECU). If the memory resource is inadequate, then proceed to block 630. In one example, inadequate memory resource is due to limited storage capacity or restricted data throughput. In one example, more than one memory resource is determined to be adequate or inadequate for the programming update. In one example, the step of block 620 is performed by a lightweight electronics control unit (ECU).

In block 630, establish a secure channel between the lightweight ECU and a central ECU. In one example, a secure channel between the lightweight ECU and a central ECU is established. In one example, the secure channel may be implemented as an upper transport layer on a lower network layer. In one example, the lower network layer is a controller area network (CAN). In one example, the lower network layer is Ethernet. In one example, the secure channel may be used to establish a secure communications facility between an ECU with limited memory resources and an ECU with sufficient memory resources for a software update or a firmware update. In one example, the step of block 630 is performed by a lightweight electronics control unit (ECU) or a central electronics control unit (ECU).

In one example, the secure channel may include a hierarchy of protocol data units (PDUs) where each PDU of the hierarchy of PDUs includes a header and a payload. In one example, the header includes routing information and control plane information. In one example, the payload includes data plane information. In one example, control plane information is used for configuration of data transport resources. In one example, data plane information is end user information transported from a source to a destination. In one example, the secure channel transports an authentic PDU to support authentication and a secured PDU to support secure transmission.

In block 640, receive a confirmation message from the central ECU that the secure channel is established. In one example, a confirmation message is received from the central ECU that the secure channel is established. In one example, the confirmation message is an acknowledgment message. In one example, the confirmation message includes a unique identifier (ID) to specify an identity of the central ECU. In one example, the step of block 640 is performed by a lightweight electronics control unit (ECU).

In block 650, send a read/write sensitive software data request message from the lightweight ECU to the central ECU. In one example, a read/write sensitive software data request message is sent from the lightweight ECU to the central ECU. In one example, the read/write sensitive software data request message specifies data type and data quantity. In one example, the read/write sensitive software data request message specifies a cryptographic algorithm and key type. In one example, the step of block 650 is performed by a lightweight electronics control unit (ECU) or a central electronics control unit (ECU).

In block 660, read a first sensitive software data as part of the programming update using a replay protected memory region, and write a second sensitive software data as part of the programming update using the replay protected memory region. In one example, a first sensitive software data is read as part of the programming update using a replay protected memory region. In one example, a second sensitive software data is written as part of the programming update using the replay protected memory region. In one example, the reading and writing use cryptographic techniques to secure the sensitive software data. In one example, the step of block 660 is performed by a replay protected memory region. In one example, sensitive software data may need replay protection (e.g., version information for software or firmware executing on a lightweight ECU).

In block 670, provide the first sensitive software data and the second sensitive software data to the central ECU as part of the programming update. In one example, the first sensitive software data and the second sensitive software data are provided to the central ECU as part of the programming update. In one example, the providing uses cryptographic techniques to secure the sensitive software data. In one example, providing includes storing the first sensitive software data and the second sensitive software data to the central ECU as part of the programming update. In one example, the step of block 670 is performed by a replay protected memory region.

In block 680, relay a message (e.g., success/failure message) to indicate completion of a successful programming update or a failed programming update. In one example, a message (e.g., success/failure message) is relayed to indicate completion of a successful programming update or a failed programming update. In one example, the success/failure message includes a timestamp to designate completion of a successful programming update. In one example, the step of block 650 is performed by a central electronics control unit (ECU). In one example, the success/failure message includes a client ID (e.g., software version update module) as a unique identifier used locally by modules or the lightweight ECU. In one example, a read/write sensitive software data request message may include the client ID. In one example, the client ID may also be included in a corresponding replay protected memory carve out for the lightweight ECU.

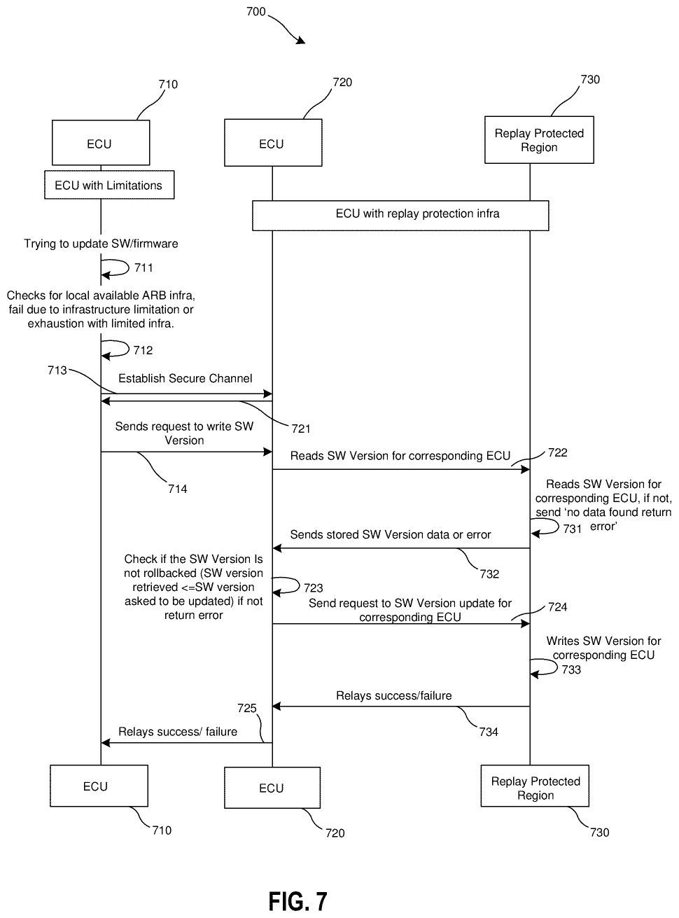

FIG. 7 illustrates an example use-case flow diagram 700 for enhanced replay attack protection in an automotive electronics system with update decision by a central electronics control unit (ECU). In one example, there are three elements in this use case flow diagram: a lightweight ECU 710, a central ECU (e.g., heavyweight ECU) 720 and a replay protected memory region 730. In one example, the replay protected memory region 730 is part of the central ECU 720. In one example, the lightweight ECU 710 has limited memory resources. In one example, the central ECU 720 has sufficient memory resources (i.e., includes the replay protected memory region 730).

In one example, the use-case flow diagram 700 commences in step 711 with an initiation of a software update or a firmware update in the lightweight ECU 710. In one example, the lightweight ECU 710 determines in step 712 that a check of locally available anti-rollback (ARB) infrastructure has failed due to a lack of resources or infrastructure or due to exhaustion of suitable memory resources (i.e., OTP registers). In one example, in step 713, the lightweight ECU 710 establishes a secure channel with the central ECU 720. In one example, in step 721, the central ECU 720 confirms establishment of the secure channel with the lightweight ECU 710. For example, the confirmation may be an acknowledgement message.

In one example, the lightweight ECU 710 sends a read/write sensitive software data request message in step 714 to the central ECU 720. In one example, the central ECU 720 reads sensitive software data as part of the software update or the firmware update in step 722 using the replay protected memory region 730. In one example, the replay protected memory region 730 retrieves the sensitive software data in step 731, if the sensitive software data is found. If no sensitive software data found, instead create a “no data found” error message in step 731. In one example, in step 732, the replay protected memory region 730 provides the sensitive software data to the central ECU 720 as part of the software update or the firmware update, or provides the “no data found” error message.

In one example, in step 723, the central ECU 720 checks if the software update is not rolled back (i.e., software version retrieved is less than or equal to the software version requested). In one example, in step 724, the central ECU 720 sends the sensitive software data to the replay protected memory region 730. In one example, in step 733, the replay protected memory region 730 writes the sensitive software data for the lightweight ECU 710. In one example, in step 734, the replay protected memory region 730 relays to the central ECU 720 a success/failure message to indicate or not a successful software update or the firmware update. In one example, in step 725, the central ECU 720 relays to the lightweight ECU 710 the success/failure message. Per the use-case flow diagram convention, ECU 710, ECU 720 and the replay protected memory region 730 are each shown twice in FIG. 7 at the beginning of the flow and at the end of the flow.

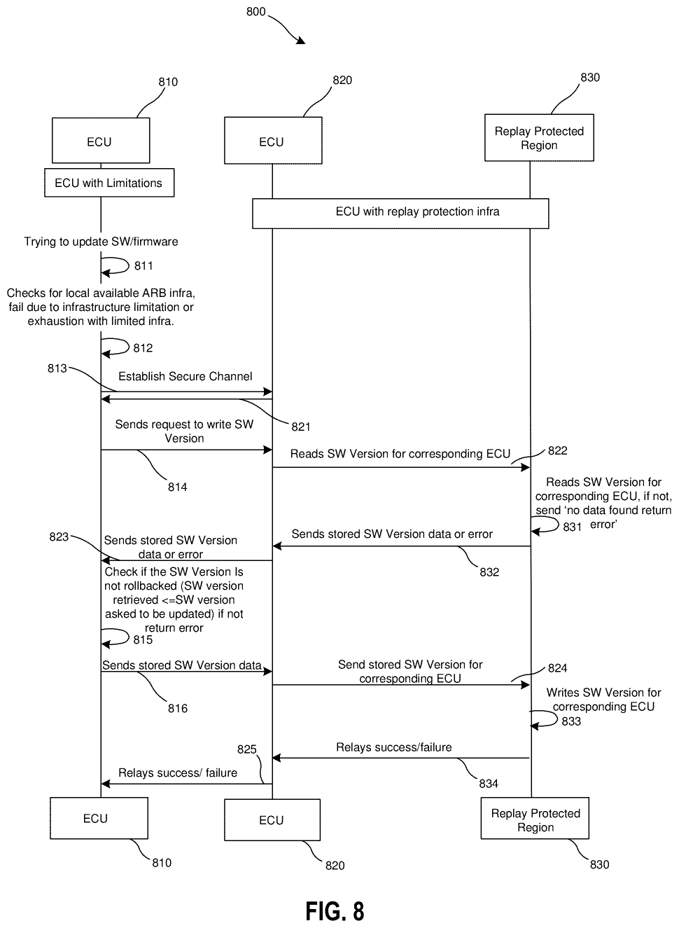

FIG. 8 illustrates an example use-case flow diagram 800 for enhanced replay attack protection in an automotive electronics system with update decision by a lightweight electronics control unit (ECU). In one example, there are three elements in this use case flow diagram: a lightweight ECU 810, a central ECU (e.g., heavyweight ECU) 820 and a replay protected memory region 830. In one example, the replay protected memory region 830 is part of the central ECU 820. In one example, the lightweight ECU 810 has limited memory resources. In one example, the central ECU 820 has sufficient memory resources (i.e., includes the replay protected memory region 830).

In one example, the use-case flow diagram 800 commences in step 811 with an initiation of a software update or a firmware update in the lightweight ECU 810. In one example, the lightweight ECU 810 determines in step 812 that a check of locally available anti-rollback (ARB) infrastructure has failed due to a lack of resources or infrastructure or due to exhaustion of suitable memory resources (i.e., OTP registers). In one example, in step 813, the lightweight ECU 810 establishes a secure channel with the central ECU 820. In one example, in step 821, the central ECU 820 confirms establishment of the secure channel with the lightweight ECU 810. For example, the confirmation may be an acknowledgement message.

In one example, the lightweight ECU 810 sends a read/write sensitive software data request message in step 814 to the central ECU 820. In one example, the central ECU 820 reads sensitive software data as part of the software update or the firmware update in step 822 using the replay protected memory region 830. In one example, the replay protected memory region 830 retrieves the sensitive software data in step 831, if the sensitive software data is found. If no sensitive software data found, instead create a “no data found” error message in step 831. In one example, in step 832, the replay protected memory region 830 provides the sensitive software data to the central ECU 820 as part of the software update or the firmware update, or provides the “no data found” error message.

In one example, in step 823, the central ECU 820 sends the sensitive software data to the lightweight ECU 810. In one example, in step 815, the lightweight ECU 810 checks if the software update is not rolled back (i.e., software version retrieved is less than or equal to the software version requested). In one example, in step 816, the lightweight ECU 810 sends the sensitive software data to the central ECU 820. In one example, in step 824, the central ECU 820 sends the sensitive software data to the replay protected memory region 830. In one example, in step 833, the replay protected memory region 830 writes the sensitive software data for the lightweight ECU 810. In one example, in step 834, the replay protected memory region 830 relays to the central ECU 820 a success/failure message to indicate or not a successful software update or the firmware update. In one example, in step 825, the central ECU 820 relays to the lightweight ECU 810 the success/failure message. Per the use-case flow diagram convention, ECU 810, ECU 820 and the replay protected memory region 830 are each shown twice in FIG. 8 at the beginning of the flow and at the end of the flow.

In one aspect, one or more of the steps for providing replay attack protection in FIG. 6 may be executed by one or more processors which may include hardware, software, firmware, etc. The one or more processors, for example, may be used to execute software or firmware needed to perform the steps in the flow diagram of FIG. 6. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a lightweight electronics control unit (ECU) configured to monitor and control functions of one or more automotive subsytems;
a central electronics control unit (ECU) coupled to the lightweight ECU, the central ECU configured to execute a programming update for the lightweight ECU; and
a secure channel coupled between the lightweight ECU and the central ECU, the secure channel configured to expose a replay protected memory region to the lightweight ECU.

2. The apparatus of claim 1, wherein the replay protected memory region for the programming update resides within the central ECU.

3. The apparatus of claim 2, wherein the programming update is a software update.

4. The apparatus of claim 2, wherein the programming update is a firmware update.

5. The apparatus of claim 1, wherein the lightweight ECU has limited memory resources, limited one-time programmable (OTP) registers or limited non-volatile memory (NVM).

6. The apparatus of claim 1, wherein the lightweight ECU has no hardware security module (HSM).

7. A method comprising:
establishing a secure channel between a lightweight electronics control unit (ECU) and a central electronics control unit (ECU);
sending a read/write sensitive software data request message from the lightweight ECU to the central ECU;
reading a first sensitive software data as part of a programming update using a replay protected memory region;
writing a second sensitive software data as part of the programming update using the replay protected memory region; and
providing the first sensitive software data and the second sensitive software data to the central ECU as part of the programming update.

8. The method of claim 7, wherein the lightweight ECU has limited memory resources, limited one-time programmable (OTP) registers or limited non-volatile memory (NVM).

9. The method of claim 7, wherein the lightweight ECU has no hardware security module (HSM).

10. The method of claim 7, wherein the secure channel is implemented as an upper transport layer on a lower network layer.

11. The method of claim 7, wherein the secure channel includes a hierarchy of protocol data units (PDUs).

12. The method of claim 11, wherein each of the hierarchy of PDUs includes a header and a payload.

13. The method of claim 12, wherein the header includes routing information and control plane information, and the payload includes data plane information.

14. The method of claim 7, further comprising relaying a message to indicate completion of a successful programming update or a failed programming update.

15. The method of claim 14, further comprising receiving a confirmation message from the central ECU that the secure channel is established.

16. The method of claim 15, further comprising determining if a memory resource in the lightweight ECU is adequate for the programming update.

17. The method of claim 16, further comprising initiating the programming update for the lightweight ECU.

18. A non-transitory computer-readable medium storing computer executable code, operable on a device comprising at least one processor and at least one memory coupled to the at least one processor, wherein the at least one processor is configured to implement replay attack protection, the computer executable code comprising:
instructions for causing a computer to establish a secure channel between a lightweight electronics control unit (ECU) and a central electronics control unit (ECU);
instructions for causing the computer to send a read/write sensitive software data request message from the lightweight ECU to the central ECU;
instructions for causing the computer to read a first sensitive software data as part of a programming update using a replay protected memory region;
instructions for causing the computer to write a second sensitive software data as part of the programming update using the replay protected memory region; and
instructions for causing the computer to provide the first sensitive software data and the second sensitive software data to the central ECU as part of the programming update.

19. The non-transitory computer-readable medium of claim 18, further comprising instructions for causing the computer to relay a message to indicate completion of a successful programming update or a failed programming update.

20. The non-transitory computer-readable medium of claim 19, further comprising instructions for causing the computer to receive a confirmation message from the central ECU that the secure channel is established.
